(19) United States
(12) Patent Application Publication
(10) Pub. No.: US 2010/0309434 A1
(43) Pub. Date: Dec. 9, 2010

(54) FRAGRANCE DISPENSER

(75) Inventors: Nicolle Hanneke Van Schijndel, Eindhoven (NL); Ronaldus Maria Aaarts, Eindhoven (NL); Fran Wu, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/867,274

(22) PCT Filed: Feb. 9, 2009
(86) PCT No.: PCT/IB09/50521

§ 371 Date: Aug. 12, 2010

(30) Foreign Application Priority Data
Feb. 15, 2008 (EP) 08151482.0

(51) Int. Cl. G03B 21/32

(52) U.S. Cl. 352/85

(57) ABSTRACT

A device for delivering a scent to a user comprises a body component, a fluid reservoir, an output component arranged to connect the fluid reservoir to the exterior of the device, and a control component arranged to receive biofeedback data and user preference data on the user, and to control the output from the fluid reservoir accordingly. The device can further comprise a sensor arranged to monitor a physiological parameter of the user and to communicate the biofeedback data to the control component. The device may also include a wireless receiver arranged to receive the user preference data and/or the biofeedback data and to communicate the data to the control component.

### FIELD OF THE INVENTION

This invention relates to a device for delivering a scent to a user and to a method of operating such a device.

### BACKGROUND OF THE INVENTION

Smell is an important sense next to, for example, sight, hearing, and touch. Smell can therefore be used to enhance multimedia experiences. Furthermore, since smell is known to influence well being, it can also be used for affecting a person's mood or emotions as is done in aromatherapy, see for example, http://en.wikipedia.org/wiki/Aromatherapy. Typically, the fragrances are dispensed in quite a large space, like a room, but this has the disadvantage that everybody within this space is affected by this odor. To overcome this disadvantage, International Patent Application Publication WO 2004/007008 describes a small fragrance dispenser which is used close to the user's nose so that only the user will smell the fragrance and not the people near the user. U.S. Pat. No. 5,610,674 describes a similar device, in addition measuring the user's breath to control individual air intake. Japanese Patent Application Publication JP 2007/020975 discloses a system that installs the fragrance dispenser near the nose by attaching it to spectacles. An additional advantage of such localized generation is that it saves odor generating material (and thereby cost), because minimal amounts are needed. Also United States of America Patent Application Publication US 2002/0018181 describes a device that generates scents directly to the nose. Furthermore, this document describes the use of a biofeedback system to control the scent delivery system.

A further example of a known system is disclosed in United States of America Patent Application Publication US 2007/062538, which discloses an intranasal insert of the type having two insert bodies which are then connected together by a transparent non-rigid elongated fiber. The transparent fiber provides for comfort to the user and allows the insert to be worn without being visible to others. The insert bodies generally contain a substance for drug delivery or control of foul odors and are placed inside the nose, one through each nostril. The design of the insert allows for easy removal from the nose and sanitary disposal by blowing into a clean tissue after use.

The inventions described above solve the problem of affecting/disturbing other people in the neighborhood of the user by applying the scent locally, in the nose of the user. These inventions do not address the personal aspects of scent stimulation itself. It is known that people can react quite differently to scents. For example, some people are much more sensitive to scents than others. In addition, responses to odors also depend on personal experiences and preferences; see for example, the document at http://www.brown.edu/Administration/News_Bureau/2004-05/04-069.html.

### SUMMARY OF THE INVENTION

It is therefore an object of the invention to improve upon the known art.

According to a first aspect of the present invention, there is provided a device for delivering a scent to a user comprising a body component, a fluid reservoir, an output component arranged to connect the fluid reservoir to the exterior of the device, and a control component arranged to receive biofeedback data and user preference data on the user, and to control the output from the fluid reservoir accordingly.

According to a second aspect of the present invention, there is provided a method of operating a device for delivering a scent to a user, the device comprising a body component, a fluid reservoir, an output component arranged to connect the fluid reservoir to the exterior of the device, and a control component, the method comprising the steps of receiving biofeedback data and user preference data on the user, and controlling the output from the fluid reservoir accordingly.

Owing to the invention, it is possible to provide a scent dispenser (for example directly in a user's nose) that will provide to the user a scent that is appropriate to their current body conditions (as provided by the biofeedback data), and also to their personal preferences about the amount and type of scent that will be delivered (and for how long), as determined from the user's profile.

It is especially important to know the user's preferences, in case undesired scents need to be masked. Furthermore, the desirable fragrance depends on the current and desired mood of the user; for example, in case a driver gets sleepy in a car, it is desirable to stimulate the user by applying a stimulating scent like lemon. Therefore, the amount of fragrance and its constitution should be personalized. This invention discloses methods to solve this. This will increase the effectiveness of the scent delivery device and has the additional advantage that, when applying it in the nose, the scent generation can be adapted rapidly.

With respect to the prior art, an essential difference of the present invention is the proposal to use user preferences. Other differences are related to the implementation of the scent generation system. For the present invention there is no need to use a complicated conduit to the user's nose and there can be provided generation directly in the nose, in one or both nostrils (different scents may be generated in the different nostrils), without the use of a conduit. The advantage of such approach is that the in-nose device is much less visible (maybe even invisible), less obtrusive, and more efficient (only minor amounts of fragrance needed for stimulation). In addition, localized administration facilitates fast switching between different scents or concentrations (almost instantaneous on/off switching).

In the present document, the term “mood” is used to indicate an emotional condition with a relatively long-term character (one can be happy for several hours or days), as compared to the term “emotion” which is more short-term (see, for example, Wikipedia (http://en.wikipedia.org/wiki/Emotion): “mood, which refers to an emotional state of duration intermediate between an emotion and a disposition.”). Another difference between mood and emotion is that emotions are usually evoked by a particular event or object (you get mad because of something that is being said to you), whereas this is not the case for moods (you are grumpy in the morning without any special reason). It should be noted however that there is still discussion about how to properly define “mood” and “emotion.” Our invention targets to influence both moods and emotions.

Odor influences emotions and mood. Accordingly, this invention discloses a method that uses fragrance to stimulate these, adapted to the personal characteristics of the user. This is obtained by measuring the emotional state of the user by means of a biofeedback system and, based on this measurement and the user's personal preferences, dispensing scent. Such personalized application is effective, can be adapted rapidly, and does not disturb other people in the vicinity of the user.

Preferably, the device further comprises a sensor arranged to monitor a physiological parameter of the user and to communicate the biofeedback data to the control component. If the device is in the nose, it can also measure heart-rate variability or other biofeedback in the nose. This removes the need to provide other additional sensors elsewhere on the body of the user, which is more efficient and effective.

In one desirable embodiment, the biofeedback data comprises data on two physiological parameters of the user, and the control component is arranged to control the output from the fluid reservoir according to a two-dimensional mapping of the data on the two physiological parameters. This data on two physiological parameters may be acquired directly by one or more sensors in the device, or may be acquired externally from the device and communicated to the control component. A two-dimensional map of the two physiological parameters can be used to position the current state (or mood) of the user and the output of the scent from the fluid reservoir can be controlled to adjust accordingly the state of the user. The device can therefore provide the control from an unwanted emotional state (such as too stressed) to a desired emotional state (which could be characterized by physiological parameters being in a predetermined range) using the biofeedback data, while taking into account the user preferences (such as for example their favorite scents, which again could be linked to a stress level). The two measured physiological parameters can be based on an arousal and valence model of the user's current state.

Advantageously, the device further comprises a wireless receiver arranged to receive the user preference data and/or the biofeedback data and to communicate the data to the control component. The provision of a wireless receiver within the scent delivery device allows information to be easily communicated to the device. This allows user settings to be adjusted in real-time and also allows data to be sent from other devices attached to the user's body, to the scent delivery device. For example, if the user is wearing a conventional heart-rate monitor that communicates wirelessly with a wristwatch that has display and input functions, then the wireless receiver in the dispenser can listen in to the wireless communications and use the heart rate information to set the scent outputs.

Ideally, the fluid reservoir within the scent delivery device comprises a plurality of separate fluid compartments. This allows greater flexibility in the provision of smells to the user, as multiple different scents can be used at different times depending upon the control components reading of the biofeedback and user profile data. Indeed the different scents stored by the reservoir can be mixed together as and when they are needed to greatly increase the different possibilities of scents that can be delivered to the user. The output component can comprise a valve, with the control component being arranged to control the valve. The use of a valve is a simple way in which the reservoir and the output component can be controlled to deliver the scent to the end user, under the control of the control device.

Preferably, the body component comprises an annular body which has all the different components of the scent dispenser contained within it. The provision of an annular shaped body, in relation to the in-nose embodiment of the invention, allows the scent delivery device to be shaped so that it will fit comfortably into the nose of the user and will remain in place without the need for any complicated fastening mechanisms. The conventional air flow through the user's nostril is unaffected, and the delivery of the scents can be into the hole in the annulus, which provides a natural delivery mechanism to the user's nose.

### BRIEF DESCRIPTION OF THE DRAWINGS

Embodiments of the present invention will now be described, by way of example only, with reference to the accompanying drawings, in which:

FIG. 1 is a schematic diagram of a first embodiment of the scent delivery device, and

FIGS. 2 to 6 are schematic diagrams of further embodiments of the scent delivery device.

### DETAILED DESCRIPTION OF THE EMBODIMENTS

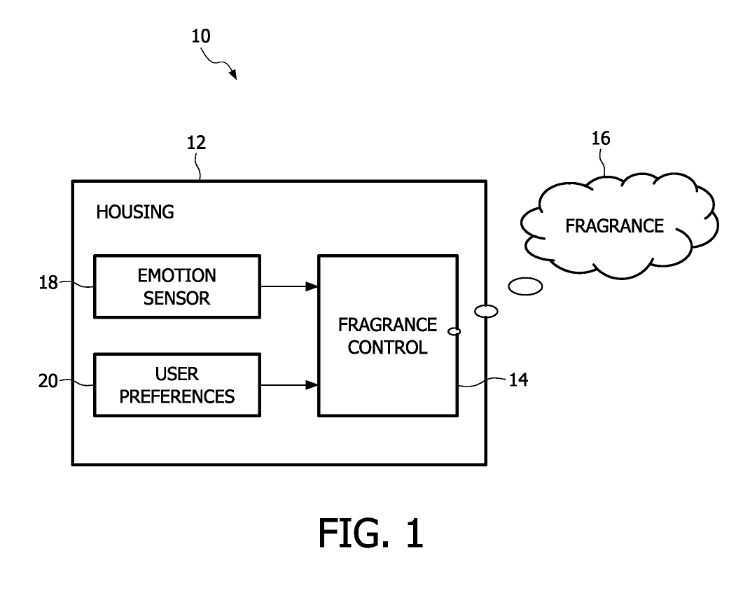

FIG. 1 shows a schematic illustration of a first embodiment of the invention. A device 10 comprises a body component 12 which contains a control component 14. The control component 14 controls the output of an odor 16. The control component 14 is arranged to receive biofeedback data from a sensor 18 and user preference data 20 on the user of the device 10. The control component 14 is arranged to control the output of the device 10 according to the received inputs from the sensor 18 and the user preferences 20.

The device 10 consists of a dispenser that releases the scent 16, for example menthol or lavender etc., to the nose of the user. The release of the odor 16 to the user can have different purposes, for example to arouse or relax the user or to mask unpleasant odors. The emotional state (emotion, mood) of the user is measured by the sensor 18, which could be a heart rate monitor or temperature monitor, for example, and based on this state and on user preferences 20, the scent that is to be output (in terms of the amount and composition for example) is adapted. This device 10 can be used to influence the mood of the user anywhere at any time.

The device 10 uses the scent 16 to influence the emotional state of the user, taking into account the user's emotional state by means of biofeedback measurements and based on the user preferences 20. The control mechanism 14 has two important sources of input information: the emotional state of the user, which is derived from biofeedback data from the sensor 18 which is monitoring a physiological parameter of the user, and the user preferences 20 of the user.

The emotional state of the user can be determined by means of the biofeedback sensor 18, which measures physical attributes like galvanic skin response and heart-rate variability. For example, in case the user is detected to be in a tense state which might do harm to his/her health or might be inappropriate in the current situation of the user, the device 10 will release relaxing scents like lavender, chamomile or eucalypt. The amount that is released is based on the stress level of the user detected by the emotional detection sensor 18.

Biofeedback measures like galvanic skin response and heart-rate variability can be used to characterize the emotional state of the user. Such characterization can be done by the well-known valence-arousal model, as described in the circumplex model by Russell (see for example Larssen, R. J., and Diener, E. (1992) “Promises and problems with the circumplex models of emotion” Review of Personality and Social Psychology, 13, pages 25 to 59). This model describes all emotions according to the two dimensions of arousal (calm-excited) and valence (positive-negative). The galvanic skin response is used to determine the degree of arousal, with an increasing galvanic skin response meaning increasing arousal of the user. The heart-rate variability is used to determine the state of valence, with an increasing coherence indicating increasing valence of the user (for more detail on this see http://en.wikipedia.org/wiki/Heart_rate_variability or http://www.heartmath.org/research/science-of-the-heart/soh_{—}14.html, last paragraph).

In an embodiment targeting the arousal axis, stimulating scents (lemon, bergamot, and rose) are generated such that the galvanic skin response increases, which indicates that the user gets more aroused. In case the generated scents do not have enough effect, in which case the measured arousal state (galvanic skin response) is still too low, the odor concentration can be increased and/or more powerful odors (such as menthol) for stimulation can be added. In an embodiment targeting the valence axis, an algorithm run by the control component 14 can be optimized for the generation of pleasant (for what is pleasant, the user preferences are used, see below) scents such that the user reaches coherence. Other points in the arousal-valence plane can be reached by combinations of the two embodiments.

The fragrance control also takes into account the preferences of the user. These user preferences 20 encompass both personal information about the desired emotional state of the user (for example, that the user would like to be in a relaxed state) and/or information about the user's personal taste, such as the scents that a user likes or dislikes (such as the fact that the user does not like sweet scents, or that he likes the perfume of his wife). Ideally, both types of information are available, such that when generating scents to evoke the desired mood of the user, the personal taste of the user can be taken into account. The user can indicate their desired state and the device 10 will react accordingly. In case the user needs to be aroused, for example because he feels sleepy but has to work, the generation device 14 releases stimulating scents like lemon, bergamot, rose and menthol. The user preferences 20 can be modified in real-time the user can for instance update their preferences 20 by indicating by means of a remote control that is wirelessly connected to the control component 14.

Both the emotional state of the user and their preferences 20 determine the amount and composition of scents that will be released. For example, in case the user wants to be relaxed, the concentration of relaxing scents will be higher in case the stress level detected by the emotional detection device is higher.

To determine some references or thresholds for the system, such as the arousal level at which the user feels stressed or the detection threshold for odor concentrations, a system is proposed that asks the user to provide feedback (for example via a remote control) when first using the device 10 and occasionally later on. In this way the device 10 can set up parameters that control the operation of the odor output that are appropriate for the specific user of the device 10. The user is able to initially configure the device 10 according to a predefined scheme (which may be a simple question and answer arrangement), and also to make changes to their user profile that are either global (changing parameters permanently) or local (for the specific occasion).

Numerous variations to the design of the device 10 of FIG. 1 are possible. Several variations on the embodiments described above could include for example, that the scent generation device 10 reacts to inputs other than emotional aspects, like time or temperature. For example, in the morning, the user is woken up with a scent of freshly baked bread. The generation device 10 could also be used as an alternative way of informing the user of a specific event that requires their attention. For example to warn the user, a burning smell is generated in case his car engine is overheated.

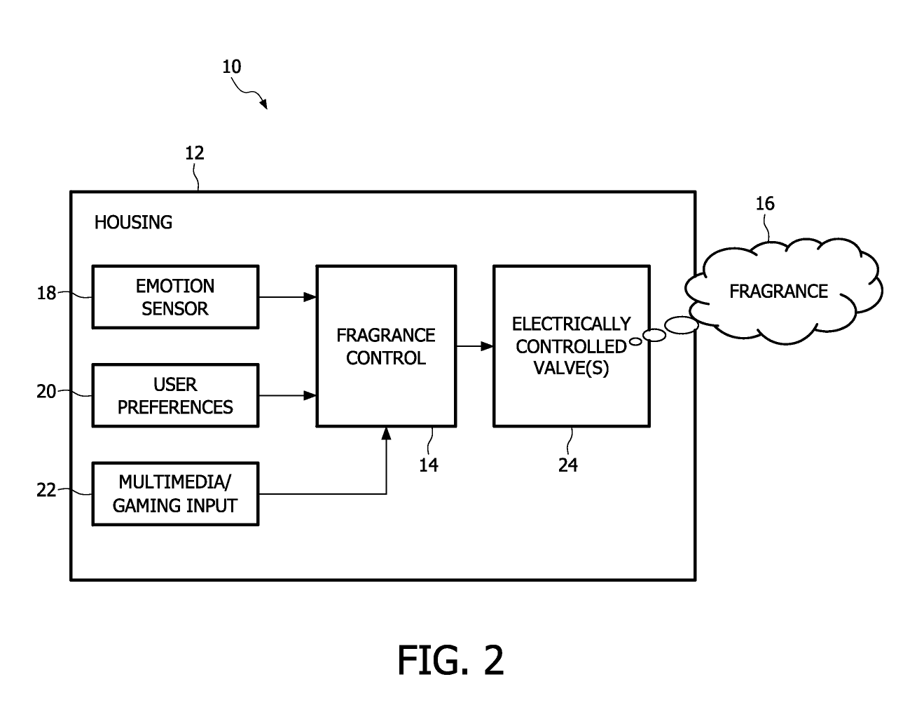

The device could also be (remotely) controlled by a multimedia device, which provides input to the fragrance control based on the contents that is being played or shown and using some scripting language. This embodiment is illustrated in more detail in FIG. 2. In addition to the inputs of the biofeedback data from the sensor 18 and the user preferences 20, an input 22 is provided from a multimedia or gaming source such as a film or a computer game. The control component 14 uses the three inputs to control valves 24 that output the fragrance 16. In this embodiment, the scent generation is synchronized with the contents of the production (program, movie, etc.). For example, when viewing a forest, the scent of a forest can be generated. As an alternative, the device 10 can be coupled to a book, enhancing the reading experience. The input 22 to the control component 14 can be related to the text or pictures in the book, again using some scripting language. The device 10 can be controlled by a gaming device (as shown in FIG. 2), which also provides input to the fragrance control 14 using some scripting (amBX-like) language. As mentioned above, the device 10 can be configured to react like an intelligent smell mask or filtering against especially air pollution.

The physical shape of the device can be such that it is able to be placed in the nose of a user. In a first embodiment, the scent generation device (the dispenser) and the mood estimation sensor 18 are mounted in the housing 12, which is placed in the nose (nostril) of the user. The odor comes from a scent chamber (fragrance reservoir) containing a liquid-phase scent or scent-laden air. In an alternative embodiment, several scent chambers can be used, containing different scents, to make mixtures. The scent is released by means of an electrically-controlled valve (for example using a piezoelectric crystal). There are different possibilities to control the amount: by varying the opening of the chamber or by varying the amount of heating of the liquid fragrance (more heating means more evaporation). The device 10 may also consist of two parts, one for each nostril, which may generate the same or different scents.

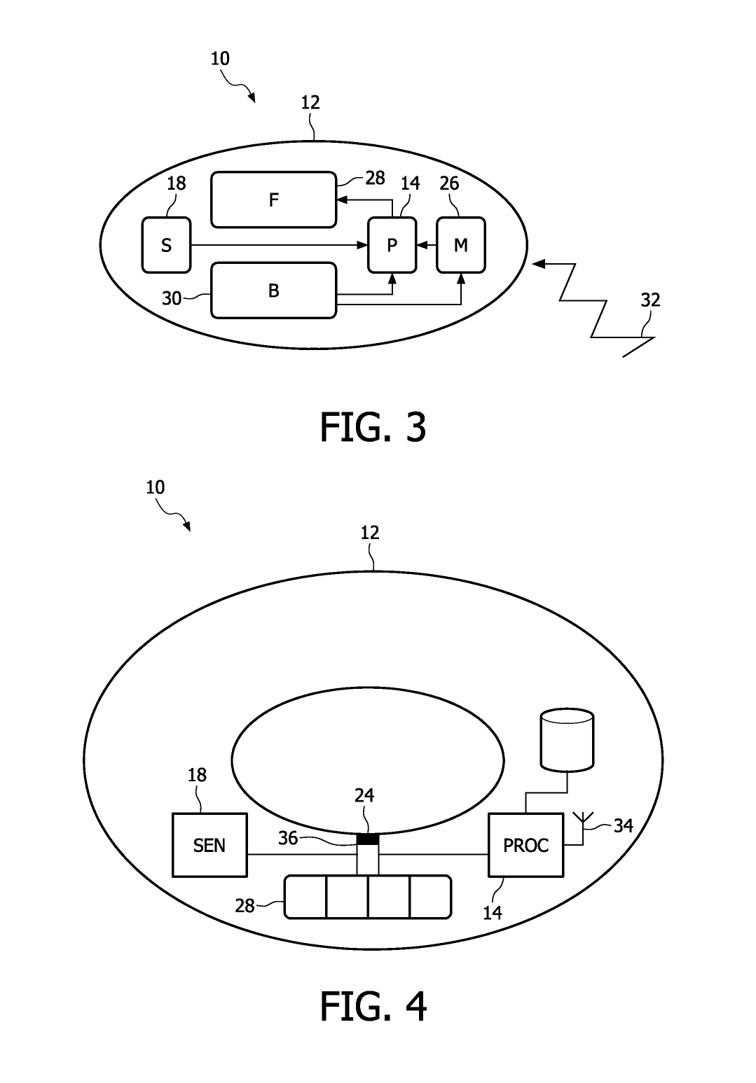

In FIG. 3, a further embodiment of the device 10 is schematically illustrated. FIG. 3 shows a small pellet (or lozenge) shaped device 10. The internal components are shown as a schematic illustration of the physical implementation of the device. The body component 12 of the device 10 contains a sensor 18, a battery 30, a fragrance reservoir 28, a memory 26, a processor 14 (which is the control component for the device 10, and a wireless receiver (not shown) that can receive wireless signals 32.

Progress in miniaturization of electronic devices and the fact that for localized scent administration only small doses are needed, make it possible to make the device 10 small enough (of the order of a couple of mm) to fit in the nose of the user. The device 10 can be attached in the nose by mechanical means (spring, clip, piercing). By means of the wireless connection 32 to a remote control or a PC, the user preferences 20 can be indicated. The fragrance dispenser 10 can be put in a docking station to charge the battery 30 and to refill the fragrance reservoir 28. There can be an indication ‘fluid reservoir’ empty, or a feedback to some base station. The device 10 can be a disposable device or part of it can be disposable, in particular the fluid reservoir 28.

As an alternative embodiment, instead of in the nose, the device 10 may be located close to the nose of the user. Alternatively, part of the generation device 10 may be located outside the nose. For example, the emotion sensor 18 may be located on a different part of the body (wrist) and may be wirelessly connected to the rest of the generation device 10. The dispenser 10 may also be located quite far from the user's nose when used in (limited) spaces that are only used by one person, such as a car, because in such cases no other people will be affected by the scent. In another embodiment, the fragrance is dispensed to other organs than the nose, like the acupuncture points on the face or on the body, affecting the user's mood; for example, the philtrum point between the nose and the mouth for energizing; the temple point outside eye contours for clearer eyesight.

A fourth embodiment of the invention is shown in FIG. 4. The device 10, which is for placing inside the nostril of a user comprises the body component 12, the fluid reservoir 28, an output component 36 arranged to connect the fluid reservoir 28 to the exterior of the device 10, and the control component 14 arranged to receive the biofeedback data and the user preference data on the user, and to control the output from the fluid reservoir 28 accordingly. The fluid reservoir 28 comprising a plurality of separate fluid compartments, which allows multiple different odors to be created. The device 10 also includes the sensor 18 arranged to monitor a physiological parameter of the user and to communicate the biofeedback data to the control component 14 and a wireless receiver 34 arranged to receive the user preference data and/or the biofeedback data from an external source and to communicate the data to the control component 14. The output component also comprises a valve 24, and the control component 14 being arranged to control the valve 24.

The body component 12 comprises an annular body 12. The Fig. shows a doughnut-shaped embodiment of the device 10, which stays in the nose of the user by mechanical, means for example by using a spring or by using elastic material for the casing such that it can slightly expand in the nose of the user. Air can flow through the middle of the body 12 which means that the device 10 does not affect the normal airflow to the user, and also provides an efficient delivery method for the odor to the user. An important aspect of the device 10 is its personalization: it adapts to the user by means of user preferences and biofeedback. Another important aspect of the system is its efficiency. Since it is located in the nose, it brings the fragrance where it is needed (and not elsewhere) with a very low dose. Instead of a doughnut-shaped device in the nose, another embodiment is via a nose piercing. This piercing can be of a bar shape, even combined as a jewel like a piercing. The device 10 is mounted on a stud that can be fitted to the user's nose through a pierced hole in their nose.

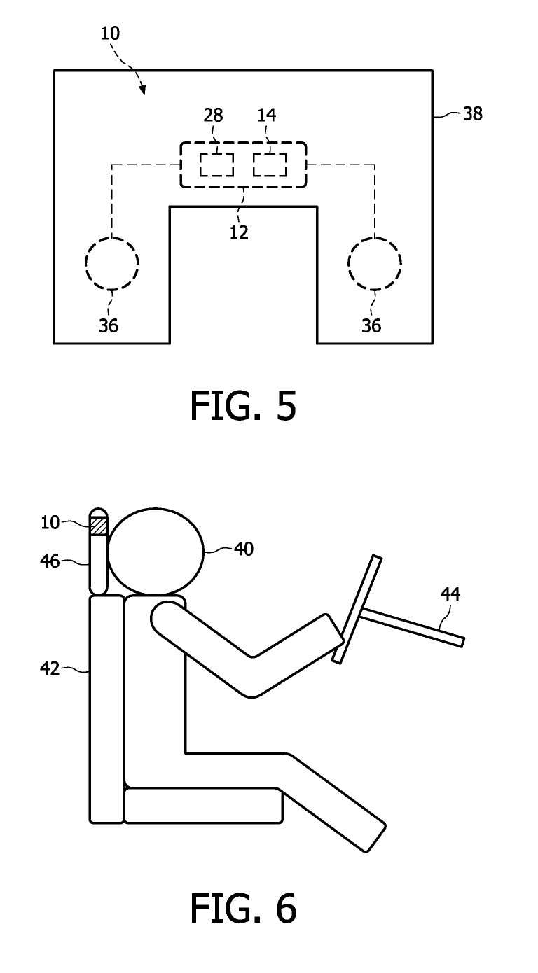

FIG. 5 shows a further embodiment of the device 10. In this embodiment, the device 10 is contained within a cushion 38. This cushion 38 (or neck pillow) is designed to be placed around the neck of a user, for example, while the user is sleeping or resting. The components of the device 10 are distributed around the interior of the pillow 38, and are sufficiently small that they cannot be detected from the exterior of the pillow 38. The body 12 contains the fluid reservoir 28 and the control component 14. The body 12 is connected to a pair of output components 36, which are provided in such a position within the pillow 28, that they are close to the nose of the user, when the pillow 38 is in use. The device 10 operates to provide a scent to the user, under the control of the control component 14. The pillow 38 could also further components of the device 10, such as one or more sensors for measuring the physiological parameters of the user, and/or a wireless receiver, as discussed above.

A yet further embodiment of the device 10 is shown in FIG. 6. In this embodiment, the user 40 is driving a vehicle, and is in contact with a seat 42 and a steering wheel. The scent delivery device 10 is included in a headrest 46, which locates the scent delivery relatively close to the nose of the user 40. The scent is delivered within the relatively confined space of the vehicle. Sensors can be located within the components in the vehicle, for example in the parts that are in direct contact with the user, such as the seat 42 and/or the steering wheel 44.

This invention can be applied in a wide range of lifestyle products. Examples are relaxation devices, aromatherapy devices, devices to mask unpleasant smells, gaming devices (amBX) and entertainment devices (enhanced experience by adding scent).

1. A device for delivering a scent (16) to a user (40) comprising:
a body component (12),
a fluid reservoir (28),
an output component (36) arranged to connect the fluid reservoir (28) to the exterior of the device, and
a control component (14) arranged to receive biofeedback data and user (40) preference data (20) on the user (40), and to control the output from the fluid reservoir (28) accordingly.

2. A device according to claim 1, and further comprising a sensor (18) arranged to monitor a physiological parameter of the user (40) and to communicate the biofeedback data to the control component (14).

3. The device according to claim 1, wherein the biofeedback data comprises data on two physiological parameters of the user (40), and the control component (14) is arranged to control the output from the fluid reservoir (28) according to a two-dimensional mapping of the data on the two physiological parameters.

4. The device according to claim 1, and further comprising a wireless receiver (34) arranged to receive the user (40) preference data (20) and/or the biofeedback data and to communicate the data to the control component (14).

5. The device according to claim 1 wherein the fluid reservoir (28) comprising a plurality of separate fluid compartments.

6. The device according to claim 1 wherein the body component (12) comprises an annular body.

7. The device according to claim 1 wherein the output component (36) comprises a valve (24), and the control component (14) is arranged to control the valve (24).

8. The device according to claim 1, wherein the device is of a size for placing inside the nostril of the user (40).

9. A method of operating a device for delivering a scent (16) to a user (40), the device comprising a body component (12), a fluid reservoir (28), an output component (36) arranged to connect the fluid reservoir (28) to the exterior of the device, and a control component (14), the method comprising the steps of:
receiving biofeedback data and user (40) preference data (20) on the user (40), and
controlling the output from the fluid reservoir (28) accordingly.

10. A method according to claim 9, and further comprising monitoring a physiological parameter of the user (40) with a sensor (18) and communicating the biofeedback data to the control component (14).

11. The method according to claim 9, wherein the biofeedback data comprises data on two physiological parameters of the user (40), and the controlling of the output from the fluid reservoir (28) is according to a two-dimensional mapping of the data on the two physiological parameters.

12. The method according to claim 9, and further comprising receiving the user (40) preference data (20) and/or the biofeedback data at a wireless receiver (34) and communicating the data to the control component (14).

13. The method according to claim 9, and further comprising operating a valve (24), wherein the control component (14) is arranged to control the valve (24).
